(19) United States
(12) Patent Application Publication
(10) Pub. No.: US 2026/0259947 A1
(43) Pub. Date: Sep. 3, 2026

(54) METHOD AND APPARATUS FOR MAKING RECOMMENDATION, AND ELECTRONIC DEVICE AND MEDIUM

(71) Applicant: Douyin Vision Co., Ltd., Beijing (CN)

(72) Inventors: Wenqiao Zhu, Beijing (CN); Chenglong Zhu, Beijing (CN); Heming Zhang, Beijing (CN); Peng Liu, Beijing (CN); Qiang He, Beijing (CN); Xun Zhou, Beijing (CN)

(21) Appl. No.: 19/159,756

(22) PCT Filed: May 9, 2024
(86) PCT No.: PCT/CN2024/092078

§ 371 Date: Aug. 26, 2025

(30) Foreign Application Priority Data
May 11, 2023 (CN) 202310532185.X

(51) Int. Cl. G06F 16/9535; G06F 16/2457; G06N 7/01

(52) U.S. Cl. CPC G06F 16/9535; G06F 16/24578; G06N 7/01

(57) ABSTRACT

Embodiments of the present disclosure relate to a method for recommendation, including acquiring a sequence of objects interacted by a user historically, the sequence of objects being sorted in an order of interaction time. The method also includes generating a sequence of object distributions based on a plurality of probability distributions of a plurality of objects in the sequence of objects. The method also includes generating a set of maximum mean discrepancy (MMD) distances by determining, based on the sequence of object distributions, an MMD distance between probability distributions of each pair of objects in the sequence of object distributions. In addition, the method also includes generating a recommendation result of recommending an object to the user based on the sequence of object distributions and the set of MMD distances.

### CROSS-REFERENCE TO RELATED APPLICATION(S)

The present application claims priority to application No. 202310532185.X, filed with the China National Intellectual Property Administration on May 11, 2023, and entitled “METHOD AND APPARATUS FOR MAKING RECOMMENDATION, AND ELECTRONIC DEVICE AND MEDIUM”, which is incorporated herein by reference in its entirety.

### FIELD

The present disclosure relates to the field of computer in general, and more particularly, to a method, apparatus, electronic device and medium for recommendation.

### BACKGROUND

A recommendation system is an information filtering system, which can predict a user's preference for certain objects by analyzing various factors such as the user's historical behaviors, so as to recommend a personalized list of objects to the user. The recommendation system is widely applied to fields such as content delivery, music and movie, social network and e-commerce.

Sequential recommendation refers to a task of performing personalized recommendation for a sequence of behaviors (e.g., reading articles, browsing videos, adding music to favorites, adding friends, etc.) generated by a user within a period of time. Compared with a traditional recommendation task, the sequential recommendation not only considers the user's interest preference, but also considers the temporal nature of the behaviors, thus conforming more to the user's practical requirements. In a scenario where the sequential recommendation is applied, the user usually generates a large amount of behavioral sequence data. How to mine useful information from the behavioral sequence data to improve the recommendation effect is a main research direction of the sequential recommendation.

### SUMMARY

Embodiments of the present disclosure provide a method, apparatus, electronic device and medium for recommendation, which can better preserve the correlation between objects by calculating the maximum mean discrepancy (MMD) distance between the probability distributions of each pair of objects, thereby facilitating cold start of new objects, increasing exposure of unpopular objects, improving the accuracy of a sequential recommendation model, and improving the user experience.

In a first aspect of the present disclosure, a method for recommendation is provided. The method includes acquiring a sequence of objects interacted by a user historically, the sequence of objects being sorted in an order of interaction time. The method further includes generating a sequence of object distributions based on a plurality of probability distributions of a plurality of objects in the sequence of objects. The method further includes generating a set of MMD distances by determining, based on the sequence of object distributions, an MMD distance between probability distributions of each pair of objects in the sequence of object distributions. In addition, the method further includes generating a recommendation result of recommending an object to the user based on the sequence of object distributions and the set of MMD distances.

In a second aspect of the present disclosure, an apparatus for recommendation is provided. The apparatus includes an object sequence acquiring module configured to acquire a sequence of objects interacted by a user historically, the sequence of objects being sorted in an order of interaction time. The apparatus further includes a distribution sequence generating module configured to generate a sequence of object distributions based on a plurality of probability distributions of a plurality of objects in the sequence of objects. The apparatus further includes a distribution distance determining module configured to generate a set of MMD distances by determining, based on the sequence of object distributions, an MMD distance between probability distributions of each pair of objects in the sequence of object distributions. In addition, the apparatus further includes a recommendation result generating module configured to generate a recommendation result of recommending an object to the user based on the sequence of object distributions and the set of MMD distances.

In a third aspect of the present disclosure, an electronic device is provided. The electronic device includes one or more processors; and a storage apparatus configured to store one or more programs, the one or more processors, when executing the one or more programs, implement a method for recommendation. The method includes acquiring a sequence of objects interacted by a user historically, the sequence of objects being sorted in an order of interaction time. The method further includes generating a sequence of object distributions based on a plurality of probability distributions of a plurality of objects in the sequence of objects. The method further includes generating a set of MMD distances by determining, based on the sequence of object distributions, an MMD distance between probability distributions of each pair of objects in the sequence of object distributions. In addition, the method further includes generating a recommendation result of recommending an object to the user based on the sequence of object distributions and the set of MMD distances.

In a fourth aspect of the present disclosure, a computer-readable storage medium is provided, on which a computer program is stored, the computer program, when executed by a processor, implements a method for recommendation. The method includes acquiring a sequence of objects interacted by a user historically, the sequence of objects being sorted in an order of interaction time. The method further includes generating a sequence of object distributions based on a plurality of probability distributions of a plurality of objects in the sequence of objects. The method further includes generating a set of MMD distances by determining, based on the sequence of object distributions, an MMD distance between probability distributions of each pair of objects in the sequence of object distributions. In addition, the method further includes generating a recommendation result of recommending an object to the user based on the sequence of object distributions and the set of MMD distances.

The summary is provided to introduce a selection of concepts in a simplified form, and they will be further described in the detailed description below. The summary is not intended to identify key features or essential features of the claimed subject matter, nor is it intended to limit the scope of the claimed subject matter.

### BRIEF DESCRIPTION OF THE DRAWINGS

The above and other features, advantages and aspects of embodiments of the present disclosure will become more apparent when taken in conjunction with the drawings and with reference to the following detailed description. In the drawings, the same or similar reference numerals refer to the same or similar elements, in which:

FIG. 1 illustrates a schematic diagram of an example environment in which multiple embodiments of the present disclosure can be implemented;

FIG. 2 illustrates a flowchart of a method for recommendation according to some embodiments of the present disclosure;

FIG. 3 illustrates a schematic diagram of a process of training a sequential recommendation model in a training stage according to some embodiments of the present disclosure;

FIG. 4 illustrates a schematic diagram of a process of calculating MMD between objects with an MMD self-attention module in a training stage according to some embodiments of the present disclosure;

FIG. 5 illustrates a schematic diagram of a process of calculating a plurality of barycenter distributions with an MMD self-attention module in a training stage according to some embodiments of the present disclosure;

FIG. 6 illustrates a schematic diagram of a process of generating a recommendation result with a sequential recommendation model in an inference stage according to some embodiments of the present disclosure;

FIG. 7 illustrates a block diagram of an apparatus for recommendation according to some embodiments of the present disclosure; and

FIG. 8 illustrates a block diagram of a device capable of implementing multiple embodiments of the present disclosure.

### DETAILED DESCRIPTION OF EMBODIMENTS

It should be understood that all data related to the user involved in the technical scheme should be acquired and used after being authorized by the user. This means that in the technical scheme, if the user's personal information needs to be used, the user's explicit consent and authorization are required before the data is acquired, otherwise the related data collection and use would not be carried out. It should also be understood that when implementing the technical scheme, relevant laws and regulations should be strictly observed in the process of collecting, using and storing data, and necessary technologies and measures should be taken to ensure the user's data security and ensure the secure use of data.

Embodiments of the present disclosure will be described in more detail below with reference to the drawings. Although some embodiments of the present disclosure are shown in the drawings, it should be understood that the present disclosure can be implemented in various forms and should not be interpreted as limited to the embodiments set forth herein. On the contrary, these embodiments are provided for a more thorough and complete understanding of the present disclosure. It should be understood that the drawings and embodiments of the present disclosure are only for exemplary purposes, and are not intended to limit the protection scope of the present disclosure.

In the description of the embodiments of the present disclosure, the term “include/comprise” and its similar expressions should be understood as open-ended inclusion, that is, “include/comprise but not limited to”. The term “based on” should be understood as “at least partially based on”. The term “an embodiment” or “the embodiment” should be understood as “at least one embodiment”. The terms “first”, “second” and the like may refer to different or the same objects, unless explicitly stated. Other explicit and implicit definitions may also be included below.

A recommendation system has become an essential part of various platforms (for example, a content delivery platform, etc.), and the recommendation system is used to solve the problem of information overload. In practical applications, interactive data between a user and an object provides an important information source for the recommendation system to generate a recommendation result. The interactive data may include behaviors of the user on the object such as clicking, adding to favorites, and rating, and these behaviors reflect the user's interest and preference for the object. By analyzing the interactive data, the recommendation system can establish a relationship between the user and the object, thereby improving the recommendation accuracy. However, in practical applications, the interaction between the user and the object is not only static, but also has a chronological order. The sequential recommendation aims to predict the next object that the user is interested in according to the user's historical behavior sequence and the current contextual information, thereby improving the recommendation effect.

Since the user's interactive behaviors are related to each other and these interactive behaviors are guided by the user's interests, the sequential recommendation can achieve good results in the recommendation task. For example, if the user likes reading, the user may browse articles related to books on the content delivery platform, and the user may also browse articles related to e-readers on the platform. In this case, whether browsing articles related to books or articles related to e-readers indicates that reading is one of the user's interests, and it is reasonable for the system to recommend articles related to books to users with these behaviors. It can be seen that the sequential recommendation has advantages in dynamic user interest modeling.

A transformer network is a neural network structure based on an attention mechanism. Inspired by the attention mechanism introduced in the transformer network, some methods attempt to apply the self-attention mechanism to solve the limitations of the Markov chain/recurrent neural network (MC/RNN)-based method. One of the main motivations of these methods is to extract context from long interaction sequences while making predictions based on a small number of behaviors. To achieve this goal, these methods utilize the self-attention mechanism to learn adaptive weights for each object in the sequence. In this way, these methods can solve the limitations of the previous MC/RNN-based methods.

Although these methods are effective, they ignore the dynamic uncertainty in sequential recommendation. Some traditional sequential recommendation methods model dynamic user interests deterministically. Specifically, these methods utilize fixed vectors in a latent space to represent the user's interests. However, the limitation of this representation is that it is difficult to model different user interests, especially real-world recommendation systems may recommend various categories of objects to users, and the user's interests are dynamic and diverse. For example, a user browses an article related to an e-reader on a content delivery platform, which may indicate that the user is interested in reading or digital technology. In this case, the recommendation system cannot determine whether the user is interested in reading or digital technology, and the fixed vector cannot capture the user's accurate interests. As a result, this leads to a degraded representation of the user's interests in the latent space of interests. In addition, some traditional sequential recommendation methods also fail to introduce the collaborative transitivity in the user behavior sequence. The collaborative transitivity can provide additional semantic relationships in the latent space in addition to providing the object-to-object transitions in the user behavior sequence. For example, based on two object transition pairs (i1→i2) and (i2→i3), it can be concluded that i1 is close to i2, and i2 is close to i3. Based on the collaborative transitivity, it can be inferred that i1 is also close to i3. However, the traditional self-attention method using dot product operation cannot well represent the collaborative transitivity. For example, assuming that i1=[0, 1], i2=[1, 1], and i3=[1, 0], the dot product operation results of (i1, i2) and (i2, i3) are both 1, while the dot product operation result of (i1, i3) is 0, indicating that i1 and i3 are far from each other in the latent space. If there is no transition between i1 and i3 in the user behavior sequence in the cold start case, the connection between them cannot be represented.

To this end, embodiments of the present disclosure propose a scheme for sequential recommendation. The scheme represents an object in the form of probability distribution, thereby converting the sequence of objects interacted by the user historically into the sequence of probability distributions of the objects. Then, the scheme utilizes the MMD to measure the distance between the probability distributions of the objects, and generates the recommendation result of recommending an object to the user based on the MMD distance between the probability distributions of these objects. In this way, the scheme proposed by the embodiments of the present disclosure can better preserve the correlation between objects, thereby facilitating cold start of new objects, increasing exposure of unpopular objects, and improving the user experience. In addition, the scheme can also improve the accuracy of the sequential recommendation model.

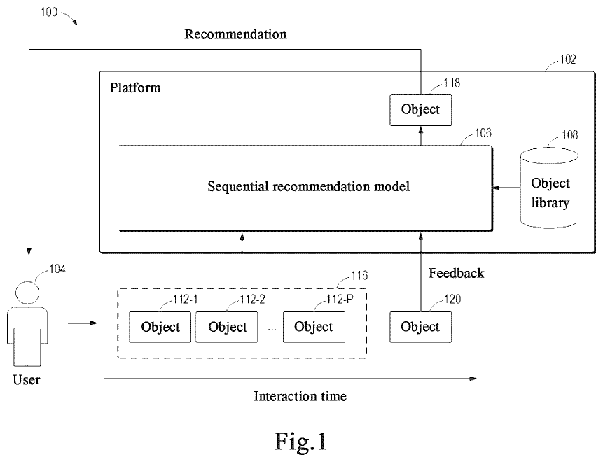

FIG. 1 illustrates a schematic diagram of an example environment 100 in which multiple embodiments of the present disclosure can be implemented. In the example shown in FIG. 1, the environment 100 includes a platform 102 and a user 104, and the platform 102 may be, for example, a content delivery platform. The platform 102 includes a sequential recommendation model 106 and an object library 108, and the object library 108 includes various objects that the user can interact with, for example, the object may be an article on the content delivery platform. The platform 102 may expose some objects in the object library 108 to the user 104, and then the user 104 can select some objects from the exposed objects to interact with them, for example, the interaction may be browsing, adding to favorites, commenting, etc. In the environment 100, the user 104 interacts with objects 112-1, 112-2, . . . , 112-P in the object library 108 in chronological order, respectively, and these objects interacted by the user form a sequence of objects 116. It should be noted that the objects in the sequence of objects 116 are sorted in the order of interaction time, that is, the user 104 first interacts with the object 112-1, then interacts with the object 112-2, and finally interacts with the object 112-P.

In the environment 100, the platform 102 inputs the sequence of objects 116 into the sequential recommendation model 106 to predict the object that the user may be interested in interacting with next time, so as to recommend the predicted object to the user 104. As shown in FIG. 1, the sequential recommendation model 106 can predict, based on the sequence of objects 116 that the user 104 has interacted with, that the object in the object library 108 that the user 104 may be interested in interacting with next time is the object 118. Then, the platform 102 exposes the object 118 to the user 104, and expects that the user 104 can interact with it. In the environment 100, the object that the user 104 actually interacts with next time is the object 120, where the object 120 may be the same object as the object 118, or may be a different object from the object 118. The user 104 interacts with the object 120 to feedback to the platform 102 whether the recommended object is accurate, thereby helping the platform 102 to optimize the sequential recommendation model 106.

It should be noted that although the recommendation result output by the sequential recommendation model 106 in the environment 100 shown in FIG. 1 includes only one object (i.e., the object 118), in some embodiments of the present disclosure, the recommendation result output by the sequential recommendation model 106 may also be a recommendation list including a plurality of objects, and the plurality of objects in the recommendation list may be sorted according to criteria such as recommendation scores. In these embodiments, the platform 102 may expose all objects in the recommendation list to the user 104, or may expose several objects ranking top in the recommendation list to the user 104.

In addition, it should be understood that the platform 102 in the environment 100 shown in FIG. 1 may be any platform that uses a recommendation system to recommend objects to users, for example, a content delivery platform, a music platform, a video platform, a social platform, an e-commerce platform, and the like. Correspondingly, the objects (e.g., the objects 112-1, 112-2, 112-P, 120, etc.) in the environment 100 shown in FIG. 1 may be any objects recommended to users by using the recommendation system, for example, articles, music, videos, people, articles, and the like.

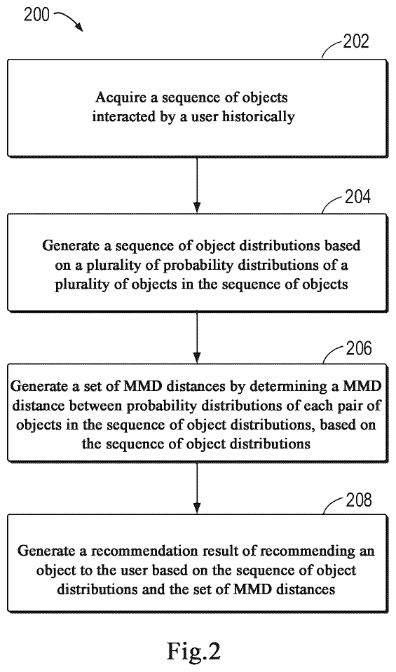

FIG. 2 illustrates a flowchart of a method 200 for recommendation according to some embodiments of the present disclosure. As shown in FIG. 2, at block 202, the method 200 acquires a sequence of objects interacted by a user historically, the sequence of objects being sorted in an order of interaction time. For example, in the environment 100 shown in FIG. 1, the method 200 acquires the sequence of objects 116, the sequence of objects 116 including the objects 112-1, 112-2, . . . , 112-P that the user 104 has interacted with on the platform 102, and all objects in the sequence of objects 116 being sorted in the order of time when the user 104 interacts with them.

At block 204, the method 200 generates a sequence of object distributions based on a plurality of probability distributions of a plurality of objects in the sequence of objects. For example, the method 200 may utilize a random distribution (e.g., a Gaussian distribution) in the sequential recommendation model 106 to generate a corresponding probability distribution for each object in the sequence of objects 116, and the probability distributions of these objects form the sequence of object distributions. Compared with the method of representing the object by using a fixed vector, the method 200 can introduce uncertainty and provide more flexibility by representing the object as a probability distribution.

At block 206, the method 200 generates a set of MMD distances by determining, based on the sequence of object distributions, an MMD distance between probability distributions of each pair of objects in the sequence of object distributions. For example, in the environment 100 shown in FIG. 1, the method 200 may utilize the sequential recommendation model 106 to calculate the MMD distance between the probability distributions of each pair of objects. The MMD is a method for estimating the difference between two probability distributions. The MMD measures the similarity between two probability distributions by calculating the norm of the difference between the means of the two probability distributions in the feature space.

At block 208, the method 200 generates a recommendation result of recommending an object to the user based on the sequence of object distributions and the set of MMD distances. For example, in the environment 100 shown in FIG. 1, the method 200 may utilize the sequential recommendation model 106 to find, from the object library 108, the object 118 that is most suitable for being recommended to the user 104 based on the sequence of object distributions corresponding to the sequence of objects 116 and the generated set of MMD distances. In some embodiments, the recommendation result output by the sequential recommendation model 106 may also be a recommendation list including a plurality of objects, and the plurality of objects in the recommendation list may be sorted according to criteria such as recommendation scores.

By representing the object as the probability distribution, the method 200 can introduce uncertainty into the sequential recommendation model 106 and provide more flexibility. In addition, in this way, the scheme proposed by the embodiments of the present disclosure can better preserve the correlation between objects by calculating the MMD distance between the probability distributions, thereby facilitating cold start of new objects, increasing exposure of unpopular objects, and improving the user experience. In addition, the scheme can also improve the accuracy of the sequential recommendation model.

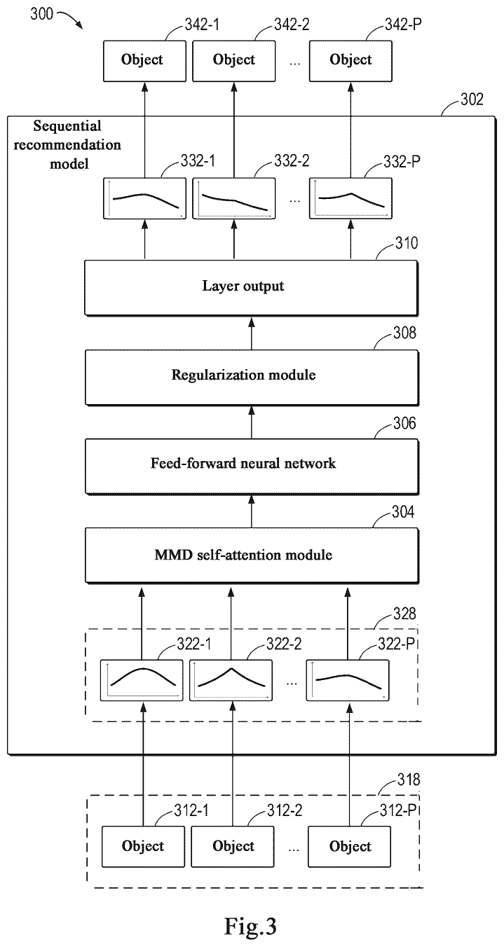

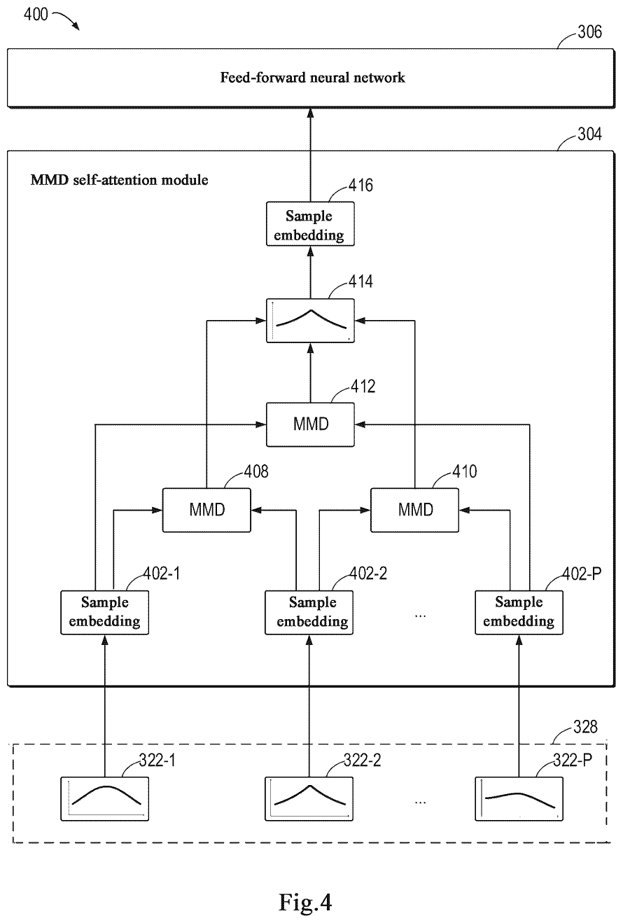

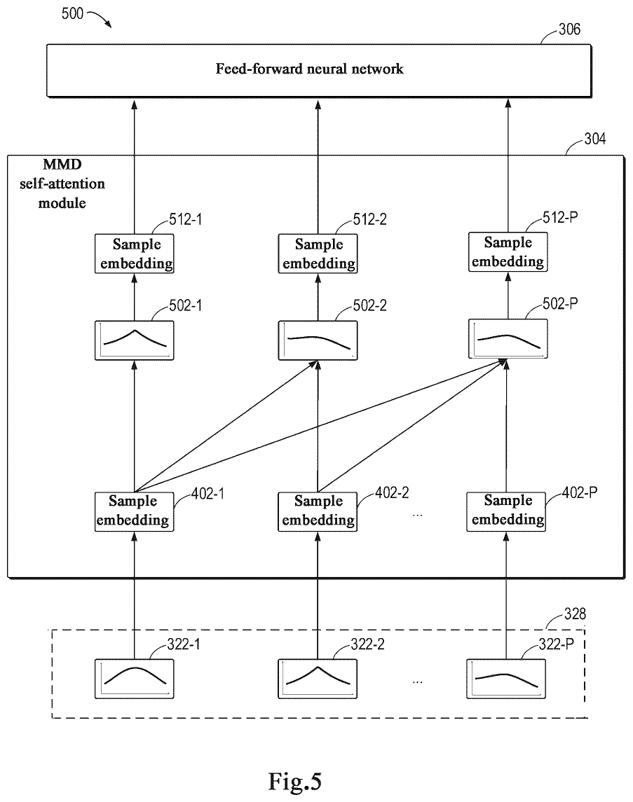

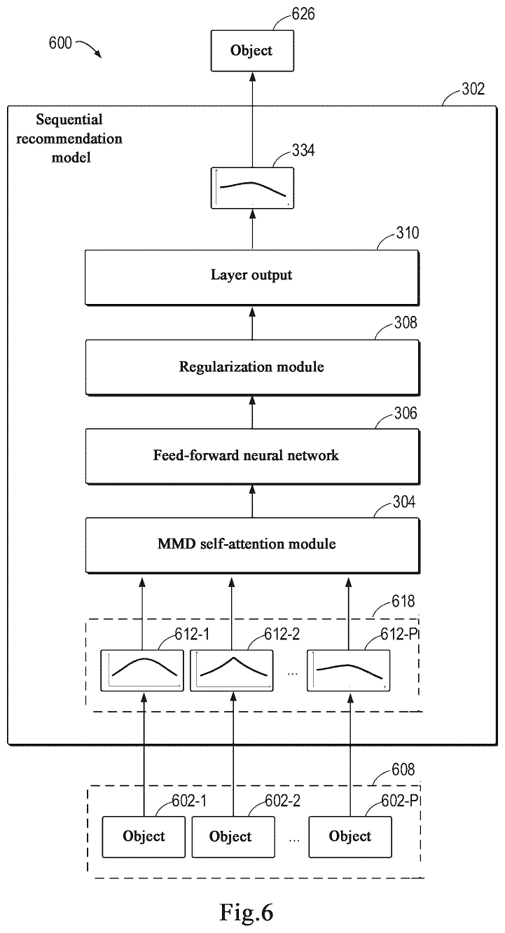

FIG. 3 to FIG. 5 illustrate schematic diagrams of a process of training the sequential recommendation model in the training stage according to some embodiments of the present disclosure. FIG. 3 illustrates an overall training process of the sequential recommendation model according to some embodiments of the present disclosure, FIG. 4 illustrates details of a part of calculating the MMD between objects with the MMD self-attention module in the overall training process according to some embodiments of the present disclosure, and FIG. 5 illustrates a process of calculating a plurality of barycenter distributions with the MMD self-attention module according to some embodiments of the present disclosure. FIG. 6 illustrates a process of generating the recommendation result with the sequential recommendation model in the inference stage according to some embodiments of the present disclosure.

FIG. 3 illustrates a schematic diagram of a process 300 of training a sequential recommendation model in a training stage according to some embodiments of the present disclosure. As shown in FIG. 3, the process 300 inputs a sequence of objects 318 interacted by a user historically into the sequential recommendation model 302, the sequence of objects 318 including objects 312-1, 312-2, . . . , 312-P (collectively referred to as the objects 312), where the objects 312 may be items on a content delivery platform, for example, products, videos, etc. Different from the traditional method of representing the object by using a deterministic vector, in the process 300, the sequential recommendation model 302 represents each object 312 in the sequence of objects 318 as a probability distribution. In some embodiments, a random distribution such as a Gaussian distribution may be utilized to represent the object 312 as a probability distribution. As shown in FIG. 3, the object 312-1 is represented as a distribution 322-1, the object 312-1 is represented as a distribution 322-2, . . . , and the object 312-P is represented as a distribution 322-P. In this way, uncertainty can be introduced into the sequential recommendation model 302 and more flexibility can be provided. The distributions 322-1, 322-2, . . . , 322-P form a sequence of object distributions 328, and in the sequence of object distributions 328, the probability distributions of all objects are sorted according to the time when the user interacts with the corresponding object.

In some embodiments, after generating the sequence of object distributions 328, the process 300 utilizes an MMD self-attention module 304 to determine the MMD distance between the probability distributions of each pair of objects in the sequence of object distributions 328, thereby generating a set of MMD distances. In some embodiments, the MMD self-attention module 304 utilizes the set of MMD distances to generate a barycenter distribution of the sequence of object distributions 328, the barycenter distribution being an average probability distribution of the sequence of object distributions 328. The barycenter distribution can represent the user's interest preference at this moment after the user interacts with the objects in the sequence of objects 318. In some embodiments, the MMD self-attention module 304 can sample the generated barycenter distribution to generate a sample embedding representing the object that the user may be interested in, and then output it to a feed-forward neural network 306.

The MMD is a metric for estimating the difference between two probability distributions, and the MMD between two probability distributions can be calculated by the following Equation (1):

$${MMD}^{2} ( {μ}_{x} , {μ}_{y} ) = {𝔼}_{x , {x}^{′} \sim {μ}_{x}} [ k ( x , {x}^{′} ) ] + {𝔼}_{y , {y}^{′} \sim {μ}_{y}} [ k ( y , {y}^{′} ) ] - 2 {𝔼}_{x \sim {μ}_{x} y \sim {μ}_{y}} [ k ( x , y ) ] \qquad ( 1 )$$

where k:X×X→R is a positive definite kernel function that measures the similarity between samples from probability distributions μₓ and μ_{y}.

The barycenter distribution is an aggregation of probability distributions. In particular, ΔP is used to represent the probability simplex

$$\{ β ∈ {R}^{P} : {\sum }_{p = 1}^{P} {β}_{p} = 1 , {β}_{p} \geq 0 \} ,$$

and [symbol] (X) represents a probability measure of X⊆R^{d}, given a set {μ₁, μ₂, . . . , μ_{P}} including P probability distributions, the barycenter distribution of these probability distributions weighted by the weight vector β can be calculated by the following Equation (2):

$${μ}^{*} = {arg}_{μ ∈ {ℳ}_{1}^{+} ( 𝒳 )} min {\sum }_{p = 1}^{P} {β}_{p} D ( μ , {μ}_{p} ) \qquad ( 2 )$$

where D: [symbol] (X)× [symbol] (X)→R⁺ represents the difference between the probability distributions, and the definition of the barycenter distribution is similar to the estimation of the mean of points in the Euclidean space.

FIG. 4 illustrates a schematic diagram of a process 400 of calculating the MMD between objects with the MMD self-attention module 304 in the training stage according to some embodiments of the present disclosure. As shown in FIG. 4, the MMD self-attention module 304 samples the probability distribution of each object in the sequence of object distributions 328 to generate a sequence of sample embeddings. For example, the MMD self-attention module 304 samples the distribution 322-1 to generate the sample embedding 402-1, samples the distribution 322-2 to generate the sample embedding 402-2, . . . , samples the distribution 322-P to generate the sample embedding 402-P. Here, the sample embeddings 402-1, 402-2, . . . , 402-P are collectively referred to as the sample embeddings 402. In this way, the scheme proposed by the present disclosure can represent the sequence of objects interacted by the user historically as a sequence of samples of probability distributions.

In some embodiments, since the relative position information of the object in the sequence is not included in the probability distribution of each object, the sequence of position embeddings may be generated by generating a trainable corresponding position embedding for each sample embedding 422 in the sequence of sample embeddings. Then, the adjusted sequence of sample embeddings may be generated based on the sequence of sample embeddings and the sequence of position embeddings. Then, the set of MMD distances may be generated based on the adjusted sequence of sample embeddings.

The process 400 shown in FIG. 4 includes P sample embeddings 402. For a given user u, the sample embeddings 402 may be represented by E^{u}=[x₁, x₂, . . . , x_{P}], where x₁ corresponds to the sample embedding 402-1, x₂ corresponds to the sample embedding 402-2, and xₚ corresponds to the sample embedding 402-P. The adjusted sequence of sample embeddings Ê^{u} may be represented by the following Equation (3):

$${\hat{E}}^{u} = [ {x}_{1} + {p}_{1} , {x}_{2} + {p}_{2} , … , {x}_{P} + {p}_{P} ] \qquad ( 3 )$$

where p₁ represents the position embedding corresponding to x₁, p₂ represents the position embedding corresponding to x₂, and p_{P} represents the position embedding corresponding to x_{P}.

In the process 400 shown in FIG. 4, a new self-attention variable may be introduced to adapt to the probability distribution of the object. In the process 400, A∈R^{n×n} represents the self-attention value, and Aᵢⱼ represents the MMD distance between the distribution μᵢ and the distribution μⱼ in the sequence of object distributions. The traditional self-attention method applies dot product operation to calculate the association between objects, but the dot product operation cannot measure the difference between the probability distributions of the objects. The difference between the probability distributions of the objects may be measured by the MMD through the following Equation (4):

$${A}_{ij} = - {MMD}^{2} ( {μ}_{i} , {μ}_{j} ) \qquad ( 4 )$$

where μᵢ and μⱼ are probability distributions corresponding to the object i and the object j in the sequence of objects.

In some embodiments, the positive definite kernel function may be utilized to calculate the MMD between the probability distributions. In some embodiments, the Gaussian kernel function may be adopted to calculate the MMD. The advantage of the Gaussian kernel function over other positive definite kernels is that the Gaussian kernel function has stronger expressive power and a wider range of applications. The Gaussian kernel function can capture the complex nonlinear structure of data, and the Gaussian kernel function has good mathematical properties, such as symmetry, positive definiteness, and differentiability, etc., so the complexity of the algorithm can be simplified. In the process 400, the Gaussian kernel function k(xᵢ,xⱼ) may be represented by the following Equation (5):

$$k ( {x}_{i} , {x}_{j} ) = α exp ( \frac{1}{2 ξ} \vert \vert {x}_{i} - {{x}_{j}}^{2} ) \qquad ( 5 )$$

where xᵢ and xⱼ represent the sample embeddings, ξ represents the bandwidth parameter, and α represents the hyperparameter for adjusting the length of the kernel function value.

As shown in FIG. 4, the process 400 determines the MMD distance between the corresponding distributions 322 by calculating the MMD between the sample embeddings 402. The MMD self-attention module 304 can calculate the MMD between two sample embeddings for each pair of sample embeddings 402. For example, the process 400 may calculate the MMD between the sample embedding 402-1 and the sample embedding 402-2 to obtain the MMD 408, calculate the MMD between the sample embedding 402-2 and the sample embedding 402-P to obtain the MMD 410, and calculate the MMD between the sample embedding 402-1 and the sample embedding 402-P to obtain the MMD 412. Then, the process 400 can generate a set of MMD distances, which includes, for example, MMD 408, 410, 412, etc. It should be understood that although the MMD between the sample embeddings 402-1, 402-2, and 402-P and other sample embeddings in the sequence of sample embeddings is not shown in FIG. 4, the process 400 calculates the MMD between each pair of sample embeddings. For example, assuming that the sequence of sample embeddings includes 4 sample embeddings, the process 400 will calculate the MMD between 6 pairs of sample embeddings respectively; assuming that the sequence of sample embeddings includes 5 sample embeddings, the process 400 will calculate the MMD between 10 pairs of sample embeddings respectively.

In some embodiments, in order to obtain the probability distribution representing the user's interest preference, the process 400 may generate the barycenter distribution 414 of the sequence of object distributions based on the sequence of object distributions 328 and the set of MMD distances. The barycenter distribution 414 is an aggregation of all distributions 322 in the sequence of object distributions 328, and the barycenter distribution 414 may represent the user's interest distribution. Then, the process 400 may sample the barycenter distribution 414 to generate the sample embedding 416, and input the sample embedding 416 into the feed-forward neural network 306. The barycenter distribution μ^{u} may be calculated by the following Equation (6):

$${μ}^{u} = {arg}_{μ ∈ {ℳ}_{1}^{+} ( 𝒳 )} min {\sum }_{p = 1}^{P} {β}_{p} {MMD}^{2} ( μ , {μ}_{p} ) \qquad ( 6 )$$

In the process 400, the weighting parameter β may be calculated by the following Equation (7):

$$β = softmax ( \frac{A}{\sqrt{d}} ) \qquad ( 7 )$$

where A represents the attention matrix, and d represents the spatial dimension.

By utilizing the MMD-based self-attention mechanism, the scheme provided by the present disclosure can utilize the Gaussian kernel function to implicitly lift the sample embedding to an infinite-dimensional feature space, thereby improving the accuracy of the sequential recommendation model 302. In addition, in the scheme, in the training process of the sequential recommendation model 302, the information contained in the probability distributions of the two objects can be fully utilized, thereby improving the collaborative transitivity between the objects, facilitating the cold start of new objects, increasing the exposure of unpopular objects, and improving the user experience.

Returning to FIG. 3, in the process 300, the MMD self-attention module 304 can output the sample embedding 416 of the barycenter distribution 414. However, the barycenter distribution is a linear aggregation of probability distributions, so that it cannot help to model complex relationships. If D=MMD², the barycenter distribution μ* of a plurality of probability distributions μ₁, μ₂, . . . , μ_{P}∈ [symbol] (X) with weights β∈Δ_{P} is a combination of a plurality of probability distributions calculated by the following Equation (8):

$${μ}^{*} := {\sum }_{p = 1}^{P} {β}_{p} {μ}_{p} \qquad ( 8 )$$

It can be seen that the sample embedding obtained by sampling the barycenter distribution will also show a linear relationship. However, since more complex relationships can be modeled by using non-linearity, in some embodiments, the sample embedding obtained by sampling the barycenter distribution can be input into the feed-forward neural network to introduce non-linearity for the sample embedding. In some embodiments, non-linearity may be introduced by including a plurality of fully connected layers in the feed-forward neural network and utilizing an exponential linear unit (ELU) activation function.

As shown in FIG. 3, the process 300 may input the sample embedding 416 of the barycenter distribution 414 output by the MMD self-attention module 304 into the feed-forward neural network 306. The feed-forward neural network 306 includes two layers, and uses the ELU activation function to generate the intermediate embedding. The output FFN(x) of the feed-forward neural network 306 can be represented by the following Equation (9):

$$FFN ( x ) = ELU ( {xW}_{1} + {b}_{1} ) {W}_{2} + {b}_{2} \qquad ( 9 )$$

where W₁∈R^{d×d}, W₂ ∈R^{d×d}, b₁ ∈R^{d} and b₂ ∈R^{d} are learnable parameters, and x may be the sample embedding 416.

As shown in FIG. 3, the process 300 may input the intermediate embedding output by the feed-forward neural network 306 into a regularization module 308, and utilize the regularization module 308 to stabilize the training process. Then, the process 400 generates the predicted embedding at the layer output 310. In some embodiments, the process 400 may apply a random drop layer to the output of the feed-forward neural network 306 to optimize the feed-forward neural network 306 to reduce the overfitting phenomenon. In some embodiments, the process 400 may generate the predicted embedding based on the sample embedding 416 and the output of the random drop layer, and utilize the residual connection and layer normalization technology. For example, for the first t objects in the sequence of objects interacted by the user historically, the predicted embedding Xₜ may be generated by the following Equation (10):

$${X}_{t} = LayerNorm ( x + Dropout ( FFN ( x ) ) ) \qquad ( 10 )$$

where Dropout( ) represents the random drop layer, LayerNorm( ) represents the layer normalization, and x may be the sample embedding 416.

The process 300 may generate a prediction distribution of the object that the user may interact with next time based on the predicted embedding. In the training stage, in order to fully utilize the training data, the process 300 may generate the prediction distribution based on the probability distributions of the first N objects in the sequence of object distributions 328, and then optimize the sequential recommendation model 302 based on a difference between the generated prediction distribution and a probability distribution of the real (N+1)th object. For example, the sequence of object distributions 328 includes P distributions 322, the process 300 may generate the prediction distribution 332-1 based on the distribution 322-1, and then optimize the sequential recommendation model 302 by comparing the difference between the prediction distribution 332-1 and the distribution 322-2. The process 300 may also generate the prediction distribution 332-2 based on the distribution 322-1 and the distribution 322-2, and then optimize the sequential recommendation model 302 by comparing the difference between the prediction distribution 332-2 and the next distribution of the distribution 322-2. By analogy, the process 300 may generate the prediction distributions 332-1, 332-2, . . . , 332-P based on the sequence of object distributions 328 (the prediction distribution 332-P needs to be compared with the probability distribution of the object that the user interacts with next time after the sequence of object distributions 328 to optimize the model). In this way, the training data can be fully utilized, and the training cost of the model can be saved.

In some embodiments, in order to generate a plurality of prediction distributions 332 by using the sequence of object distributions 328, a plurality of barycenter distributions may be generated in the MMD self-attention module. FIG. 5 illustrates a schematic diagram of a process 500 of calculating a plurality of barycenter distributions with the MMD self-attention module in the training stage according to some embodiments of the present disclosure. As shown in FIG. 5, the MMD self-attention module 304 samples the distributions 322-1, 322-2, . . . , 322-P in the sequence of object distributions 328 to generate the sample embeddings 402-1, 402-2, . . . , 402-P. The process 500 may generate the barycenter distribution 502-1 based on the sample embedding 402-1, and then sample the barycenter distribution 502-1 to generate the sample embedding 512-1. The process 500 may also generate the barycenter distribution 502-2 based on the sample embeddings 402-1 and 402-2, and then sample the barycenter distribution 502-2 to generate the sample embedding 512-2. The process 500 may also generate the barycenter distribution 502-P based on all P sample embeddings 402, and then sample the barycenter distribution 502-P to generate the sample embedding 512-P. In this way, the sequential recommendation model 302 can generate a plurality of prediction distributions 332 based on the plurality of barycenter distributions 502, thereby achieving full utilization of the training data and saving the training cost of the model. It should be understood that for clarity, the process of calculating the MMD between the sample embeddings 402 is not shown in FIG. 5, but the process of generating the barycenter distribution 502 based on the sample embeddings 402 described above includes all the details of generating the barycenter distribution by calculating the MMD between the sample embeddings as shown in FIG. 4.

Returning to FIG. 3, in some embodiments, the process 300 may determine the MMD distances between the prediction distributions and the probability distributions of the target objects in the object library 108 shown in FIG. 1, and then select the object with the smallest MMD distance as the recommendation result. In other embodiments, a plurality of objects with the smallest MMD distances or a plurality of objects with MMD distances less than a predetermined threshold may be selected as the recommendation result. For example, as shown in FIG. 3, the process 300 determines the MMD distances between the prediction distributions 332-1, 332-2, . . . , 332-P and the target objects in the object library 108, respectively, thereby determining the objects 342-1, 342-2, . . . , 342-P as the recommendation result. The MMD distance [symbol] _{t,i} between the prediction distribution μₜ generated based on the first t interactive objects and the probability distribution μᵢ of the ith target object in the object library 108 may be determined by the following Equation (11):

$${\hat{y}}_{t , i} = - {MMD}^{2} ( {μ}_{t} , {μ}_{i} ) \qquad ( 11 )$$

When optimizing the sequential recommendation model 302 during the training stage, in some embodiments, the Bayesian personalized ranking (BPR) loss may be utilized as a main objective function to measure the ranking prediction error. The main objective function (also referred to as a first loss function) [symbol] ₘ is shown in the following Equation (12):

$${ℒ}_{m} = - {\sum }_{{𝒮}^{u} ∈ 𝒮} {\sum }_{t = 1}^{\vert {𝒮}^{u} \vert} log ( σ ( {\hat{y}}_{t , i} - {\hat{y}}_{t , {i}^{′}} ) ) \qquad ( 12 )$$

where S represents the sequence of objects interacted by the user historically, S^{u} represents the sequence of objects interacted by the user u historically, σ is a sigmoid function, ŷ_{t,i} is the MMD distance between the prediction distribution generated based on the first t objects in the sequence of objects and the probability distribution of the positive sample (the sample that the user actually interacts with next time), and is the MMD distance between the prediction distribution generated based on the first t objects in the sequence of objects and the probability distribution of the negative sample (the sample that the user does not interact with).

In some embodiments, a regularization term (also referred to as a second loss function) may be generated by using a hinge loss function to improve the representation learning. The regularization term [symbol] ₚᵥₙ is shown in the following Equation (13):

$${ℒ}_{pvn} = {[ {d}_{{s}_{i} , j +} , {d}_{{s}_{i} , {j}^{-}} ]}_{+} \qquad ( 13 )$$

where [x]₊=max(x,0) is the hinge loss function, dₛ_{ₜ}_{,j}+ represents the distance between the prediction distribution and the positive sample, and dₛ_{ₜ}_{,j}− represents the distance between the prediction distribution and the negative sample.

In some embodiments, the main objective function may be combined with the regularization term to generate a multi-task objective function (also referred to as a third loss function). The multi-task objective function [symbol] is shown in the following Equation (14):

$$ℒ = {ℒ}_{m} + {λℒ}_{pvn} \qquad ( 14 )$$

where λ is a hyperparameter used to adjust the length of the [symbol] ₚᵥₙ loss.

In the inference stage, the platform 102 may input the sequence of objects interacted by the user historically into the sequential recommendation model 302, and then the sequential recommendation model 302 generates the recommendation result recommended to the user based on all objects in the sequence of objects. FIG. 6 illustrates a schematic diagram of a process 600 of generating a recommendation result with a sequential recommendation model in an inference stage according to some embodiments of the present disclosure.

As shown in FIG. 6, the sequential recommendation model 302 acquires a sequence of objects 608 interacted by a user historically, the sequence of objects 608 including objects 602-1, 602-2, . . . , 602-P (collectively referred to as the objects 602). The process 600 may represent each object 602 in the sequence of objects 608 as a probability distribution, that is, distributions 612-1, 612-2, . . . , 612-P (collectively referred to as the distributions 612). Then, the process 600 utilizes the MMD self-attention module 304 to calculate the MMD distance between the probability distributions of each pair of objects in the sequence of object distributions 618, and then generates the barycenter distribution of the sequence of object distributions 618 based on the set of MMD distances. The process 600 may sample the barycenter distribution to generate the corresponding sample embedding. Then, via the feed-forward neural network 306, the regularization module 308 and the layer output 310, the process 600 may generate the prediction distribution 334 based on the sample embedding of the barycenter distribution. Then, the process 600 may determine the MMD distance between the prediction distribution 334 and the probability distribution of the target object in the object library 108, and then select the object 626 with the smallest MMD distance from the prediction distribution 334 as the recommendation result to be recommended to the user.

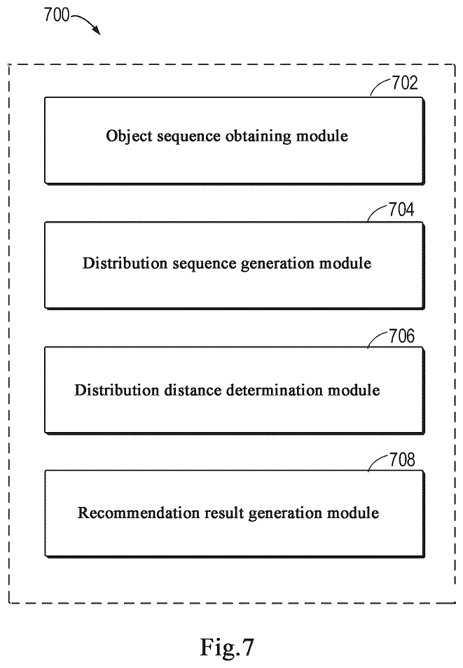

FIG. 7 illustrates a block diagram of an apparatus 700 for recommendation according to some embodiments of the present disclosure. As shown in FIG. 7, the apparatus 700 includes an object sequence acquiring module 702 configured to acquire a sequence of objects interacted by a user historically, the sequence of objects being sorted in an order of interaction time. The apparatus 700 further includes a distribution sequence generating module 704 configured to generate a sequence of object distributions based on a plurality of probability distributions of a plurality of objects in the sequence of objects. The apparatus 700 further includes a distribution distance determining module 706 configured to generate a set of MMD distances by determining, based on the sequence of object distributions, an MMD distance between probability distributions of each pair of objects in the sequence of object distributions. In addition, the apparatus 700 further includes a recommendation result generating module 708 configured to generate a recommendation result of recommending an object to the user based on the sequence of object distributions and the set of MMD distances.

It can be understood that, through the apparatus 700 of the present disclosure, at least one of many advantages that can be achieved by the method or process described above can be achieved. For example, by using the MMD to measure the distance between the probability distributions of the objects and generating the recommendation result of recommending an object to the user based on the MMD distance between the probability distributions of these objects, the correlation between the objects can be better preserved, thereby facilitating the cold start of new objects, increasing the exposure of unpopular objects, and improving the user experience. In addition, the accuracy of the sequential recommendation model can also be improved.

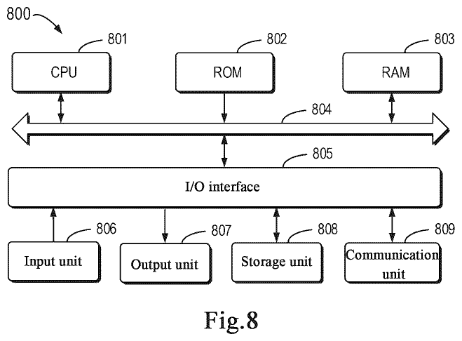

FIG. 8 illustrates a block diagram of an electronic device 800 according to certain embodiments of the present disclosure, and the device 800 may be the device or apparatus described in the embodiments of the present disclosure. As shown in FIG. 8, the device 800 includes a central processing unit (CPU) and/or a graphics processing unit (GPU) 801, which can perform various appropriate actions and processing according to computer program instructions stored in a read-only memory (ROM) 802 or computer program instructions loaded from a storage unit 808 into a random access memory (RAM) 803. Various programs and data required for the operation of the device 800 may also be stored in the RAM 803. The CPU/GPU 801, the ROM 802, and the RAM 803 are connected to each other through a bus 804. An input/output (I/O) interface 805 is also connected to the bus 804. Although not shown in FIG. 8, the device 800 may also include a co-processor.

Multiple components in the device 800 are connected to the I/O interface 805, including: an input unit 806, such as a keyboard, a mouse, etc.; an output unit 807, such as various types of displays, speakers, etc.; a storage unit 808, such as a magnetic disk, an optical disk, etc.; and a communication unit 809, such as a network card, a modem, a wireless communication transceiver, etc. The communication unit 809 allows the device 800 to exchange information/data with other devices through a computer network such as the Internet and/or various telecommunication networks.

The respective methods or processes described above can be executed by the CPU/GPU 801. For example, in some embodiments, the method can be implemented as a computer software program, which is tangibly contained in a machine-readable medium, such as the storage unit 808. In some embodiments, part or all of the computer program can be loaded and/or installed on the device 800 via the ROM 802 and/or the communication unit 809. When the computer program is loaded into the RAM 803 and executed by the CPU/GPU 801, one or more steps or actions in the method or process described above can be executed.

In some embodiments, the methods and processes described above can be implemented as a computer program product. The computer program product may include a computer-readable storage medium on which computer-readable program instructions for performing various aspects of the present disclosure are loaded.

The computer-readable storage medium may be a tangible device that can hold and store instructions used by the instruction executing device. The computer-readable storage medium may be, for example, but not limited to, an electrical storage device, a magnetic storage device, an optical storage device, an electromagnetic storage device, a semiconductor storage device, or any suitable combination of the above. More specific examples of the computer-readable storage medium (a non-exhaustive list) include: a portable computer disk, a hard disk, a random access memory (RAM), a read-only memory (ROM), an erasable programmable read-only memory (EPROM or a flash memory), a static random access memory (SRAM), a portable compact disk read-only memory (CD-ROM), a digital versatile disk (DVD), a memory stick, a floppy disk, a mechanical coding device, for example, a punched card or a groove convex structure on which instructions are stored, and any suitable combination of the above. The computer-readable storage medium used here is not interpreted as a transient signal itself, such as a radio wave or other freely propagating electromagnetic wave, an electromagnetic wave propagating through a waveguide or other transmission medium (for example, an optical pulse through an optical fiber cable), or an electrical signal transmitted through a wire.

The computer-readable program instructions described herein may be downloaded from a computer-readable storage medium to various computing/processing devices, or downloaded to an external computer or an external storage device via a network, such as the Internet, a local area network, a wide area network, and/or a wireless network. The network may include copper transmission cables, optical fiber transmission, wireless transmission, routers, firewalls, switches, gateway computers, and/or edge servers. A network adapter card or a network interface in each computing/processing device receives computer-readable program instructions from the network and forwards the computer-readable program instructions for storage in a computer-readable storage medium in the respective computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, where the programming languages include object-oriented programming languages and conventional procedural programming languages. The computer-readable program instructions may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider). In some embodiments, the electronic circuit may be customized by using state information of the computer-readable program instructions, such as a programmable logic circuit, a field programmable gate array (FPGA) or a programmable logic array (PLA), and the electronic circuit can execute the computer-readable program instructions to implement various aspects of the present disclosure.

These computer-readable program instructions may be provided to a processing unit of a general-purpose computer, a special-purpose computer or other programmable data processing apparatus to produce a machine, such that the instructions, when executed by the processing unit of the computer or other programmable data processing apparatus, produce an apparatus for implementing functions/acts specified in one or more blocks in the flowcharts and/or block diagrams. These computer-readable program instructions may also be stored in a computer-readable storage medium, and these instructions cause the computer, the programmable data processing apparatus and/or other devices to work in a specific manner, such that the computer-readable medium storing the instructions includes an article of manufacture, which includes instructions for implementing various aspects of the functions/acts specified in one or more blocks in the flowcharts and/or block diagrams.

These computer-readable program instructions may also be loaded into the computer, other programmable data processing apparatus or other devices, such that a series of operation steps are executed on the computer, the other programmable data processing apparatus or other devices to produce a computer-implemented process, such that the instructions executed on the computer, the other programmable data processing apparatus or other devices implement the functions/acts specified in one or more blocks in the flowcharts and/or block diagrams.

The flowcharts and block diagrams in the drawings show possible architectures, functions and operations of the device, method and computer program product according to multiple embodiments of the present disclosure. In this regard, each block in the flowcharts or block diagrams may represent a module, a program segment or part of instructions, and the module, the program segment or part of instructions includes one or more executable instructions for implementing specified logical functions. In some alternative implementations, the functions marked in the blocks may also occur in an order different from those marked in the drawings. For example, two consecutive blocks may actually be executed substantially in parallel, or they may sometimes be executed in a reverse order, depending on the functions involved. It should also be noted that each block in the block diagrams and/or flowcharts and the combination of blocks in the block diagrams and/or flowcharts may be implemented by a dedicated hardware-based system that performs specified functions or acts, or may be implemented by a combination of dedicated hardware and computer instructions.

Various embodiments of the present disclosure have been described above, and the above description is exemplary, not exhaustive, and is not limited to the disclosed embodiments. Many modifications and changes are obvious to those of ordinary skill in the art without departing from the scope and spirit of the described embodiments. The selection of terms used herein is intended to best explain the principles, practical applications, or technical improvements of the technology in the market of the embodiments, or to enable other ordinary skilled in the art to understand the embodiments disclosed herein.

Some example implementations of the present disclosure are listed below.

Example 1. A method for recommendation, including:
acquiring a sequence of objects interacted by a user historically, the sequence of objects being sorted
in an order of interaction time;
generating a sequence of object distributions based on a plurality of probability distributions of a plurality of objects in the sequence of objects;
generating a set of maximum mean discrepancy (MMD) distances by determining, based on the sequence of object distributions, an MMD distance between probability distributions of each pair of objects in the sequence of object distributions; and
generating a recommendation result of recommending an object to the user based on the sequence of object distributions and the set of MMD distances.

Example 2. The method according to Example 1, where determining the MMD distance between the probability distributions of each pair of objects in the sequence of object distributions includes:
generating a sequence of sample embeddings by sampling a probability distribution of each object in the sequence of object distributions.

Example 3. The method according to Example 2, where determining the MMD distance between the probability distributions of each pair of objects in the sequence of object distributions further includes:
generating a sequence of position embeddings by generating a trainable corresponding position embedding for each sample embedding in the sequence of sample embeddings;
generating an adjusted sequence of sample embeddings based on the sequence of sample embeddings and the sequence of position embeddings; and
generating the set of MMD distances based on the adjusted sequence of sample embeddings.

Example 4. The method according to Example 3, where determining the MMD distance between the probability distributions of each pair of objects in the sequence of object distributions further includes:
determining an MMD between a first sample embedding and a second sample embedding in the adjusted sequence of sample embeddings,
wherein the first sample embedding corresponds to a probability distribution of a first object in the sequence of object distributions, the second sample embedding corresponds to a probability distribution of a second object in the sequence of object distributions, and the MMD indicates an MMD distance between the probability distribution of the first object and the probability distribution of the second object.

Example 5. The method according to Example 4, where determining the MMD between the first sample embedding and the second sample embedding includes:
determining the MMD by using a Gaussian kernel function based on the first sample embedding, the second sample embedding, a bandwidth parameter and a hyperparameter.

Example 6. The method according to Example 1, where generating the recommendation result of recommending an object to the user includes:
generating a barycenter distribution of the sequence of object distributions based on the sequence of object distributions and the set of MMD distances, the barycenter distribution being an average probability distribution of the sequence of object distributions;
generating a predicted probability distribution based on the barycenter distribution of the sequence of object distributions; and
generating the recommendation result based on the predicted probability distribution.

Example 7. The method according to Example 6, where generating the barycenter distribution of the sequence of object distributions includes:
determining a weighting parameter for the sequence of object distributions based on the set of MMD distances; and
generating the barycenter distribution of the sequence of object distributions based on the sequence of object distributions and the weighting parameter.

Example 8. The method according to Example 6, where generating the predicted probability distribution includes:
generating a barycenter sample embedding by sampling the barycenter distribution of the sequence of object distributions; and
generating an intermediate embedding by using a feed-forward neural network and an exponential linear unit (ELU) activation function based on the barycenter sample embedding, the feed-forward neural network comprising a plurality of fully connected layers.

Example 9. The method according to Example 8, where generating the predicted probability distribution further includes:
generating a predicted embedding by using a residual connection, layer normalization and a random drop layer based on the barycenter sample embedding and the intermediate embedding; and
generating the predicted probability distribution based on the predicted embedding.

Example 10. The method according to Example 6, where generating the recommendation result further includes:
generating a set of predicted MMD distances by determining an MMD distance between the predicted probability distribution and a probability distribution of each target object in a target object library; and
determining the recommendation result based on the set of predicted MMD distances.

Example 11. The method according to Example 6, further including:
generating a first loss function by using Bayesian personalized ranking based on the predicted probability distribution, a probability distribution of a positive sample that the user actually interacts with next time, and a probability distribution of a negative sample that the user has not interacted with.

Example 12. The method according to Example 11, further including:
generating a second loss function by using a hinge loss function based on the predicted probability distribution, the probability distribution of the positive sample, and the probability distribution of the negative sample.

Example 13. The method according to Example 12, further including:
generating a joint loss function based on the first loss function and the second loss function; and
generating a sequential recommendation model by using the joint loss function.

Example 14. An apparatus for recommendation, including:
an object sequence acquiring module configured to acquire a sequence of objects interacted by a user historically, the sequence of objects being sorted in an order of interaction time;
a distribution sequence generating module configured to generate a sequence of object distributions based on a plurality of probability distributions of a plurality of objects in the sequence of objects;
a distribution distance determining module configured to generate a set of maximum mean discrepancy (MMD) distances by determining, based on the sequence of object distributions, an MMD distance between probability distributions of each pair of objects in the sequence of object distributions; and
a recommendation result generating module configured to generate a recommendation result of recommending an object to the user based on the sequence of object distributions and the set of MMD distances.

Example 15. The apparatus according to Example 14, where determining the MMD distance between the probability distributions of each pair of objects in the sequence of object distributions includes:
an object distribution sampling module configured to generate a sequence of sample embeddings by sampling a probability distribution of each object in the sequence of object distributions.

Example 16. The apparatus according to Example 15, where determining the MMD distance between the probability distributions of each pair of objects in the sequence of object distributions further includes:
a position embedding generating module configured to generate a sequence of position embeddings by generating a trainable corresponding position embedding for each sample embedding in the sequence of sample embeddings;
a position embedding using module configured to generate an adjusted sequence of sample embeddings based on the sequence of sample embeddings and the sequence of position embeddings; and
a distance set generating module configured to generate the set of MMD distances based on the adjusted sequence of sample embeddings

Example 17. The apparatus according to Example 16, where determining the MMD distance between the probability distributions of each pair of objects in the sequence of object distributions further includes:
a distribution distance determining module configured to determine an MMD between a first sample embedding and a second sample embedding in the adjusted sequence of sample embeddings,
wherein the first sample embedding corresponds to a probability distribution of a first object in the sequence of object distributions, the second sample embedding corresponds to a probability distribution of a second object in the sequence of object distributions, and the MMD indicates an MMD distance between the probability distribution of the first object and the probability distribution of the second object.

Example 18. The apparatus according to Example 17, where determining the MMD between the first sample embedding and the second sample embedding includes:
a kernel function using module configured to determine the MMD by using a Gaussian kernel function based on the first sample embedding, the second sample embedding, a bandwidth parameter and a hyperparameter.

Example 19. The apparatus according to Example 14, where generating the recommendation result of recommending an object to the user includes:
a barycenter distribution generating module configured to generate a barycenter distribution of the sequence of object distributions based on the sequence of object distributions and the set of MMD distances, the barycenter distribution being an average probability distribution of the sequence of object distributions;
a prediction distribution generating module configured to generate a predicted probability distribution based on the barycenter distribution of the sequence of object distributions; and
a prediction distribution using module configured to generate the recommendation result based on the predicted probability distribution.

Example 20. The apparatus according to Example 20, where generating the barycenter distribution of the sequence of object distributions includes:
a weighting parameter determining module configured to determine a weighting parameter for the sequence of object distributions based on the set of MMD distances; and
a weighting parameter using module configured to generate the barycenter distribution of the sequence of object distributions based on the sequence of object distributions and the weighting parameter.

Example 21. The apparatus according to Example 19, where generating the predicted probability distribution includes:
a barycenter distribution sampling module configured to generate a barycenter sample embedding by sampling the barycenter distribution of the sequence of object distributions; and
an intermediate embedding generating module configured to generate an intermediate embedding by using a feed-forward neural network and an exponential linear unit (ELU) activation function based on the barycenter sample embedding, the feed-forward neural network comprising a plurality of fully connected layers.

Example 22. The apparatus according to Example 21, where generating the predicted probability distribution further includes:
a predicted embedding generating module configured to generate a predicted embedding by using a residual connection, layer normalization and a random drop layer based on the barycenter sample embedding and the intermediate embedding; and
a prediction distribution generating module configured to generate the predicted probability distribution based on the predicted embedding.

Example 23. The apparatus according to Example 19, where generating the recommendation result further includes:
a prediction distance generating module configured to generate a set of predicted MMD distances by determining an MMD distance between the predicted probability distribution and a probability distribution of each target object in a target object library; and
a prediction distance using module configured to determine the recommendation result based on the set of predicted MMD distances.

Example 24. The apparatus according to Example 19, further including:
a first loss generating module configured to generate a first loss function by using Bayesian personalized ranking based on the predicted probability distribution, a probability distribution of a positive sample that the user actually interacts with next time, and a probability distribution of a negative sample that the user has not interacted with.

Example 25. The apparatus according to Example 24, further including:
a second loss generating module configured to generate a second loss function by using a hinge loss function based on the predicted probability distribution, the probability distribution of the positive sample, and the probability distribution of the negative sample.

Example 26. The apparatus according to Example 25, further including:
a third loss generating module configured to generate a joint loss function based on the first loss function and the second loss function; and
a third loss using module configured to generate a sequential recommendation model by using the joint loss function.

Example 27. An electronic device, including:
a processor, and
a memory coupled to the processor, the memory having instructions stored therein, the instructions, when executed by the processor, causing the electronic device to perform acts, the acts including:
acquiring a sequence of objects interacted by a user historically, the sequence of objects being sorted in an order of interaction time;
generating a sequence of object distributions based on a plurality of probability distributions of a plurality of objects in the sequence of objects;
generating a set of maximum mean discrepancy (MMD) distances by determining, based on the sequence of object distributions, an MMD distance between probability distributions of each pair of objects in the sequence of object distributions; and
generating a recommendation result of recommending an object to the user based on the sequence of object distributions and the set of MMD distances.

Example 28. The electronic device according to Example 27, where determining the MMD distance between the probability distributions of each pair of objects in the sequence of object distributions includes:
generating a sequence of sample embeddings by sampling a probability distribution of each object in the sequence of object distributions.

Example 29. The electronic device according to Example 28, where determining the MMD distance between the probability distributions of each pair of objects in the sequence of object distributions further includes:
generating a sequence of position embeddings by generating a trainable corresponding position embedding for each sample embedding in the sequence of sample embeddings;
generating an adjusted sequence of sample embeddings based on the sequence of sample embeddings and the sequence of position embeddings; and
generating the set of MMD distances based on the adjusted sequence of sample embeddings.

Example 30. The electronic device according to Example 29, where determining the MMD distance between the probability distributions of each pair of objects in the sequence of object distributions further includes:
determining an MMD between a first sample embedding and a second sample embedding in the adjusted sequence of sample embeddings,
wherein the first sample embedding corresponds to a probability distribution of a first object in the sequence of object distributions, the second sample embedding corresponds to a probability distribution of a second object in the sequence of object distributions, and the MMD indicates an MMD distance between the probability distribution of the first object and the probability distribution of the second object.

Example 31. The electronic device according to Example 30, where determining the MMD between the first sample embedding and the second sample embedding includes:
determining the MMD by using a Gaussian kernel function based on the first sample embedding, the second sample embedding, a bandwidth parameter and a hyperparameter.

Example 32. The electronic device according to Example 27, where generating the recommendation result of recommending an object to the user includes:
generating a barycenter distribution of the sequence of object distributions based on the sequence of object distributions and the set of MMD distances, the barycenter distribution being an average probability distribution of the sequence of object distributions;
generating a predicted probability distribution based on the barycenter distribution of the sequence of object distributions; and
generating the recommendation result based on the predicted probability distribution.

Example 33. The electronic device according to Example 32, where generating the barycenter distribution of the sequence of object distributions includes:
determining a weighting parameter for the sequence of object distributions based on the set of MMD distances; and
generating the barycenter distribution of the sequence of object distributions based on the sequence of object distributions and the weighting parameter.

Example 34. The electronic device according to Example 32, where generating the predicted probability distribution includes:
generating a barycenter sample embedding by sampling the barycenter distribution of the sequence of object distributions; and
generating an intermediate embedding by using a feed-forward neural network and an exponential linear unit (ELU) activation function based on the barycenter sample embedding, the feed-forward neural network comprising a plurality of fully connected layers.

Example 35. The electronic device according to Example 34, where generating the predicted probability distribution further includes:
generating a predicted embedding by using a residual connection, layer normalization and a random drop layer based on the barycenter sample embedding and the intermediate embedding; and
generating the predicted probability distribution based on the predicted embedding.

Example 36. The electronic device according to Example 32, where generating the recommendation result further includes:
generating a set of predicted MMD distances by determining an MMD distance between the predicted probability distribution and a probability distribution of each target object in a target object library; and
determining the recommendation result based on the set of predicted MMD distances.

Example 37. The electronic device according to Example 32, further including:
generating a first loss function by using Bayesian personalized ranking based on the predicted probability distribution, a probability distribution of a positive sample that the user actually interacts with next time, and a probability distribution of a negative sample that the user has not interacted with.

Example 38. The electronic device according to Example 37, further including:
generating a second loss function by using a hinge loss function based on the predicted probability distribution, the probability distribution of the positive sample, and the probability distribution of the negative sample.

Example 39. The electronic device according to Example 38, further including:
generating a joint loss function based on the first loss function and the second loss function; and
generating a sequential recommendation model by using the joint loss function.

Although the present disclosure has been described in language specific to structural features and/or logical actions of the method, it should be understood that the subject matter defined in the appended claims is not necessarily limited to the specific features or actions described above. On the contrary, the specific features and actions described above are merely example forms for implementing the claims.

1. A method for recommendation, comprising:
acquiring a sequence of objects interacted by a user historically, the sequence of objects being sorted in an order of interaction time;
generating a sequence of object distributions based on a plurality of probability distributions of a plurality of objects in the sequence of objects;
generating a set of maximum mean discrepancy (MMD) distances by determining, based on the sequence of object distributions, an MMD distance between probability distributions of each pair of objects in the sequence of object distributions; and
generating a recommendation result of recommending an object to the user based on the sequence of object distributions and the set of MMD distances.

2. The method according to claim 1, wherein determining the MMD distance between the probability distributions of each pair of objects in the sequence of object distributions comprises:
generating a sequence of sample embeddings by sampling a probability distribution of each object in the sequence of object distributions.

3. The method according to claim 2, wherein determining the MMD distance between the probability distributions of each pair of objects in the sequence of object distributions further comprises:
generating a sequence of position embeddings by generating a trainable corresponding position embedding for each sample embedding in the sequence of sample embeddings;
generating an adjusted sequence of sample embeddings based on the sequence of sample embeddings and the sequence of position embeddings; and
generating the set of MMD distances based on the adjusted sequence of sample embeddings.

4. The method according to claim 3, wherein determining the MMD distance between the probability distributions of each pair of objects in the sequence of object distributions further comprises:
determining an MMD between a first sample embedding and a second sample embedding in the adjusted sequence of sample embeddings,
wherein the first sample embedding corresponds to a probability distribution of a first object in the sequence of object distributions, the second sample embedding corresponds to a probability distribution of a second object in the sequence of object distributions, and the MMD indicates an MMD distance between the probability distribution of the first object and the probability distribution of the second object.

5. The method according to claim 4, wherein determining the MMD between the first sample embedding and the second sample embedding comprises:
determining the MMD by using a Gaussian kernel function based on the first sample embedding, the second sample embedding, a bandwidth parameter and a hyperparameter.

6. The method according to claim 1, wherein generating the recommendation result of recommending the object to the user comprises:
generating a barycenter distribution of the sequence of object distributions based on the sequence of object distributions and the set of MMD distances, the barycenter distribution being an average probability distribution of the sequence of object distributions;
generating a predicted probability distribution based on the barycenter distribution of the sequence of object distributions; and
generating the recommendation result based on the predicted probability distribution.

7. The method according to claim 6, wherein generating the barycenter distribution of the sequence of object distributions comprises:
determining a weighting parameter for the sequence of object distributions based on the set of MMD distances; and
generating the barycenter distribution of the sequence of object distributions based on the sequence of object distributions and the weighting parameter.

8. The method according to claim 6, wherein generating the predicted probability distribution comprises:
generating a barycenter sample embedding by sampling the barycenter distribution of the sequence of object distributions; and
generating an intermediate embedding by using a feed-forward neural network and an exponential linear unit (ELU) activation function based on the barycenter sample embedding, the feed-forward neural network comprising a plurality of fully connected layers.

9. The method according to claim 8, wherein generating the predicted probability distribution further comprises:
generating a predicted embedding by using a residual connection, layer normalization and a random drop layer based on the barycenter sample embedding and the intermediate embedding; and
generating the predicted probability distribution based on the predicted embedding.

10. The method according to claim 6, wherein generating the recommendation result further comprises:
generating a set of predicted MMD distances by determining an MMD distance between the predicted probability distribution and a probability distribution of each target object in a target object library; and
determining the recommendation result based on the set of predicted MMD distances.

11. The method according to claim 6, further comprising:
generating a first loss function by using Bayesian personalized ranking based on the predicted probability distribution, a probability distribution of a positive sample that the user actually interacts with next time, and a probability distribution of a negative sample that the user has not interacted with.

12. The method according to claim 11, further comprising:
generating a second loss function by using a hinge loss function based on the predicted probability distribution, the probability distribution of the positive sample, and the probability distribution of the negative sample.

13. The method according to claim 12, further comprising:
generating a joint loss function based on the first loss function and the second loss function; and
generating a sequential recommendation model by using the joint loss function.

14. (canceled)

15. An electronic device, comprising:
a processor; and
a memory coupled to the processor, wherein the memory has instructions stored therein, and the instructions, when executed by the processor, cause the electronic device to:
acquire a sequence of objects interacted by a user historically, the sequence of objects being sorted in an order of interaction time;
generate a sequence of object distributions based on a plurality of probability distributions of a plurality of objects in the sequence of objects;
generate a set of maximum mean discrepancy (MMD) distances by determining, based on the sequence of object distributions, an MMD distance between probability distributions of each pair of objects in the sequence of object distributions; and
generate a recommendation result of recommending an object to the user based on the sequence of object distributions and the set of MMD distances.

16. A non-transitory computer-readable storage medium having computer-executable instructions stored thereon, wherein the computer-executable instructions, when executed by a processor, cause an electronic device to:
acquire a sequence of objects interacted by a user historically, the sequence of objects being sorted in an order of interaction time;
generate a sequence of object distributions based on a plurality of probability distributions of a plurality of objects in the sequence of objects;
generate a set of maximum mean discrepancy (MMD) distances by determining, based on the sequence of object distributions, an MMD distance between probability distributions of each pair of objects in the sequence of object distributions; and
generate a recommendation result of recommending an object to the user based on the sequence of object distributions and the set of MMD distances.

17. The electronic device according to claim 15, wherein the instructions causing the electronic device to determine the MMD distance between the probability distributions of each pair of objects in the sequence of object distributions comprise instructions causing the electronic device to:
generating a sequence of sample embeddings by sampling a probability distribution of each object in the sequence of object distributions.

18. The electronic device according to claim 17, wherein the instructions causing the electronic device to determine the MMD distance between the probability distributions of each pair of objects in the sequence of object distributions further comprise instructions causing the electronic device to:
generate a sequence of position embeddings by generating a trainable corresponding position embedding for each sample embedding in the sequence of sample embeddings;
generate an adjusted sequence of sample embeddings based on the sequence of sample embeddings and the sequence of position embeddings; and
generate the set of MMD distances based on the adjusted sequence of sample embeddings.

19. The electronic device according to claim 18, wherein the instructions causing the electronic device to determine the MMD distance between the probability distributions of each pair of objects in the sequence of object distributions further comprise instructions causing the electronic device to:
determine an MMD between a first sample embedding and a second sample embedding in the adjusted sequence of sample embeddings,
wherein the first sample embedding corresponds to a probability distribution of a first object in the sequence of object distributions, the second sample embedding corresponds to a probability distribution of a second object in the sequence of object distributions, and the MMD indicates an MMD distance between the probability distribution of the first object and the probability distribution of the second object.

20. The electronic device according to claim 19, wherein the instructions causing the electronic device to determine the MMD between the first sample embedding and the second sample embedding comprise instructions causing the electronic device to:
determine the MMD by using a Gaussian kernel function based on the first sample embedding, the second sample embedding, a bandwidth parameter and a hyperparameter.

21. The electronic device according to claim 15, wherein the instructions causing the electronic device to generate the recommendation result of recommending the object to the user comprise instructions causing the electronic device to:
generate a barycenter distribution of the sequence of object distributions based on the sequence of object distributions and the set of MMD distances, the barycenter distribution being an average probability distribution of the sequence of object distributions;
generate a predicted probability distribution based on the barycenter distribution of the sequence of object distributions; and
generate the recommendation result based on the predicted probability distribution.
